(19) United States
(12) Patent Application Publication
(10) Pub. No.: US 2004/0162124 A1
(43) Pub. Date: Aug. 19, 2004

(54) Mobile gaming system and method

(76) Inventor: Lewis Barton, Vero Beach, FL (US)

Correspondence Address: Kevin J. McNeely, Esq., 5301 Wriley Road, Bethesda, MD, 20816, US

(21) Appl. No.: 10/780,873

(22) Filed: Feb. 19, 2004

Related U.S. Application Data
(60) Provisional application No. 60/447,937, filed on Feb. 19, 2003.

(51) Int. Cl. G06F 17/00; G06F 19/00

(52) U.S. Cl. 463/1

(57) ABSTRACT

A method of gaming in a mobile casino supervised from a supervisory location includes collecting data from the mobile casino and sending the data to the supervisory location. The data collected may include payoff information, gaming revenue information, video surveillance information, or geographic position information. The method may also include changing an operating mode of gaming equipment in the mobile casino based on the geographic position information.

### CROSS-REFERENCE TO RELATED APPLICATION

This application claims priority to provisional patent application number 60/447,937 filed on Feb. 19, 2003, which is incorporated herein by reference.

### FIELD OF THE INVENTION

This invention relates to gaming or gambling, and, more particularly, to gaming in a mobile environment.

### BACKGROUND OF THE INVENTION

Casino gaming and other types of gambling activities, where money is bet on the outcome of a game, contest, or other event, are enjoyed worldwide. Gaming is usually conducted in a fixed location, such as, for example, in a hotel, casino or other facility with a fixed foundation. Casinos have slot machines which are used to gamble by inserting coins and tables that are set-up for activities such as roulette, craps, and card games, as well as sports-betting centers, and other gambling-related equipment, collectively referred to as gaming equipment. Casinos are designed with sufficient space to provide a secure and comfortable setting for gaming patrons. For example, an elaborate video surveillance system may be used to supervise the gaming tables, the casino employees, and the gaming patrons.

Casinos may be subject to state and local laws relating to gambling in that jurisdiction. Frequently, these laws have certain reporting requirements to provide revenue and/or winnings information and to ensure certain betting odds.

Gaming in a mobile environment, such as, for example, in a bus, train, trailer, van, boat, aircraft, or other motorized vehicle, collectively referred to as a mobile casino, presents certain problems, such as, for example, a limited amount of space and less secure facilities. Mobile casinos also are potentially subjected to conflicting gaming laws and reporting requirements of more than one jurisdiction.

### SUMMARY OF THE INVENTION

In one general aspect, a method of gaming in a mobile casino supervised from a supervisory location and/or managed by a control center includes collecting data from the mobile casino and sending the data to the supervisory location. Implementation may include one or more of the following features. For example, the collecting may include collecting payoff information, gaming revenue information, video surveillance information, and/or geographic position information. The method may also include changing an operating mode of gaming equipment in the mobile casino based on the geographic position information.

In various implementations, the mobile casino may be located in a train, a bus, a trailer, a boat, a van, an aircraft, or other motorized vehicle. Sending the data may be performed by wireless transmission to a master computer at the supervisory location, which may be a fixed location.

In another general aspect, a mobile gaming system configured to be installed in a vehicle and supervised from a supervisory location includes gaming equipment, an on-board computer linked to the gaming equipment, a vibration absorbing mounting device mounting the gaming equipment to the vehicle, and a master computer at the supervisory location receiving data from and sending data to the on-board computer. Implementation may include a global positioning system module reporting the position of the vehicle and/or one or more of the features described above.

In another general aspect, a method of supervising a gaming operation in a mobile casino includes collecting gaming data and position information from the mobile casino, transmitting the gaming data and position information to a control center, and calculating gaming revenue at each location of the mobile casino based on the gaming data and the position information.

In another general aspect, a method of producing a mobile casino includes mounting gaming equipment in a motorized vehicle. Implementation may include installing communication equipment, mounting the gaming equipment via shock absorption devices, and/or one or more of the features described above.

### BRIEF DESCRIPTION OF THE DRAWINGS

FIG. 1 illustrates a mobile casino supervised from a fixed location;

FIG. 2 shows a gaming control system for the mobile casino of FIG. 1; and

FIGS. 3 and 4 illustrate methods of mobile gaming.

### DETAILED DESCRIPTION

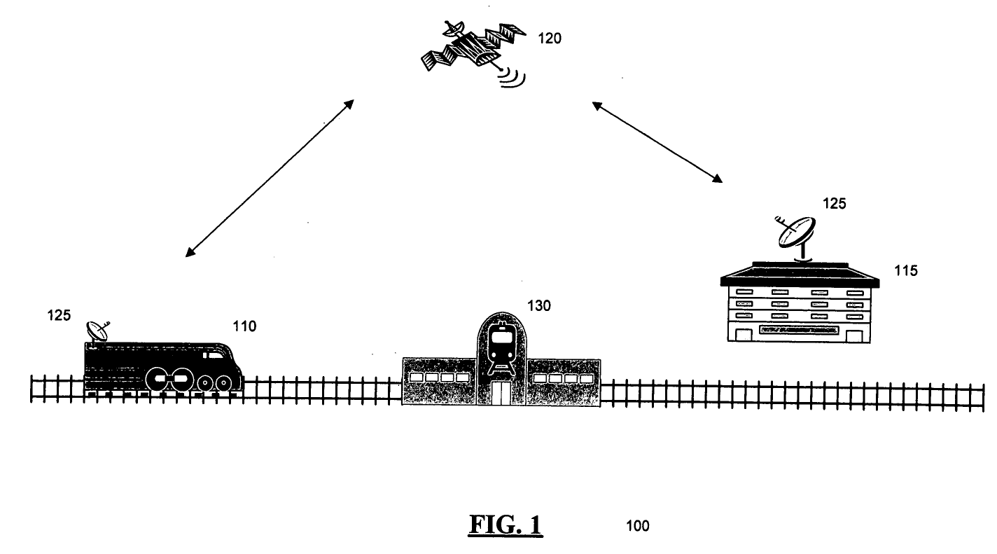

Referring to FIG. 1, a mobile gaming system 100 comprises a train 110 in communication with a supervisory location 115. The mobile gaming system 100 could also be implemented with other types of vehicles, such as, for example, a bus, trailer, plane, boat, van, or aircraft (not shown).

The communication system includes a satellite 120 and satellites dishes 125 installed on the train 110 and at the supervisory location 115. The communication system allows data transmission between the train and the supervisory location 115.

Gaming equipment installed on a train 110 would be subject to jolting movements, vibration, and tilting that could harm equipment, affect its operation, or cause a loss in calibration of the equipment. Thus, gaming equipment on the train 110 could be installed with mounting devices that are designed to provide shock absorption and to protect the equipment from such jolts, vibration, and tilting.

Gaming on vans, which include vehicles having an enclosed gaming area separate from the driver's compartment, and buses would have similar problems with vibrations and sudden stops. While gaming in a trailer would likely take place once the trailer is set up for gaming at a particular destination, gaming equipment could be damaged or miscalibrated during travel, thus also requiring shock absorption.

In other embodiments, communication between the train 110 and the supervisory location is performed by other methods. For example, the communication system may include infra-red or microwave transmission. Communication may also be performed over telecommunications networks, such as, for example, a cellular telephone network or by a wireless local area network, such as, for example, an IEEE 802.11 WLAN. In another embodiment, data is downloaded from the train when it pulls into a train station 130 or is stored on a computer data disk and removed at the train station 130.

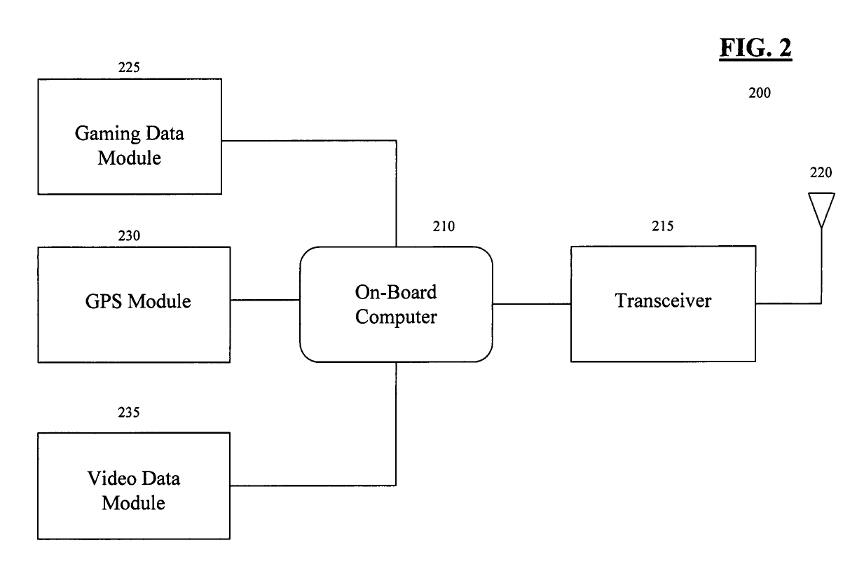

Referring to FIG. 2, a gaming control system 200 controls communication between the train and the supervisory location 115. The gaming control system 200 includes an on-board computer 210 and a transceiver 215 connected to an antenna 220, such as, for example, the satellite dish 125. The on-board computer 210 may include various input/output (I/O) devices (mouse, keyboard, display), a central processor unit (CPU), an I/O unit, a memory device, and a storage medium that stores data and various programs, such as an operating system, and one or more application programs. The on-board computer 210 may also include a communications card or device (e.g., a modem or network adapter) for exchanging data with a network. The on-board computer 210 operates on a set of programmable instructions and controls the flow of data to the transceiver 215. The gaming control system can provide real-time flow of information, such as, for example, current position, equipment status, and video surveillance while the train 110 is in motion.

Data is provided to the on-board computer 210 from a gaming data module 225, a global positioning system module (GPS) 230, and a surveillance data module 235. The gaming data module 225 collects revenue, payoff, and/or winning information from gaming equipment installed on the train 110. For example, slot machines may download information to the gaming data module 225 or a dealer or dealer supervisor may enter information at a terminal to report payoff information from a gaming table.

The GPS module 230 reports the position of the train in real-time, stores the information, and forwards it to the on-board computer 210. The surveillance data module 235 collects and stores video surveillance data from cameras and/or audio data from microphones that are installed in various locations throughout the train 110. The modules 225, 230, and 235, may include storage devices, such as, for example, a hard drive or an optical disk, and may also include separate processors.

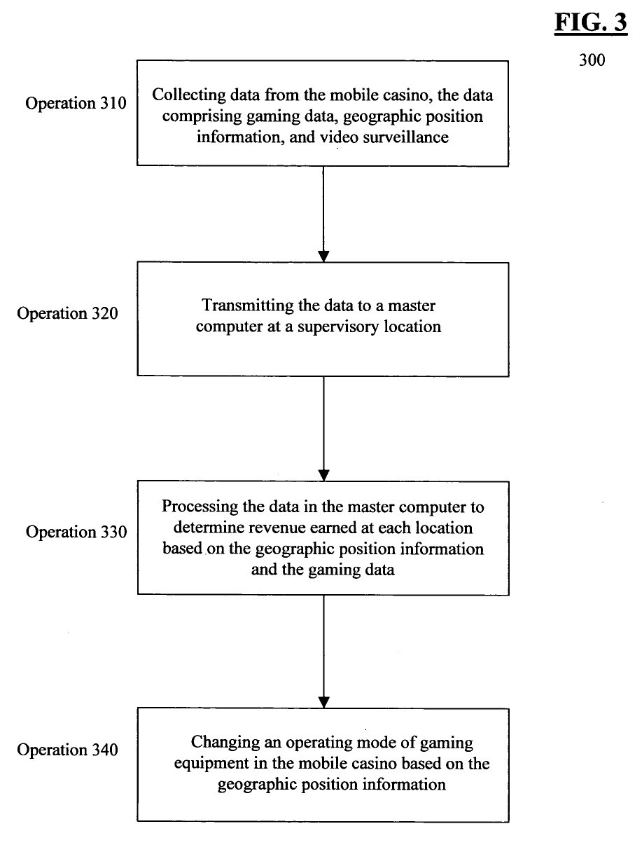

FIG. 3 illustrates a method of mobile gaming 300. In operation 310, data is collected at the mobile casino. The data can include gaming data, geographic position, and video surveillance. The gaming data may include, for example, gross and/or net gaming revenue or payoff information. The video surveillance data and the location of the mobile casino may be reviewed by private security at the supervisory location and/or may be forwarded to law enforcement personnel.

In operation 320, the data is transmitted to a master computer at the supervisory location. In operation 330, the master computer analyzes or processes the data to extract winning information, such as, for example, the amount of money earned by the casino in a specific location or within a jurisdiction.

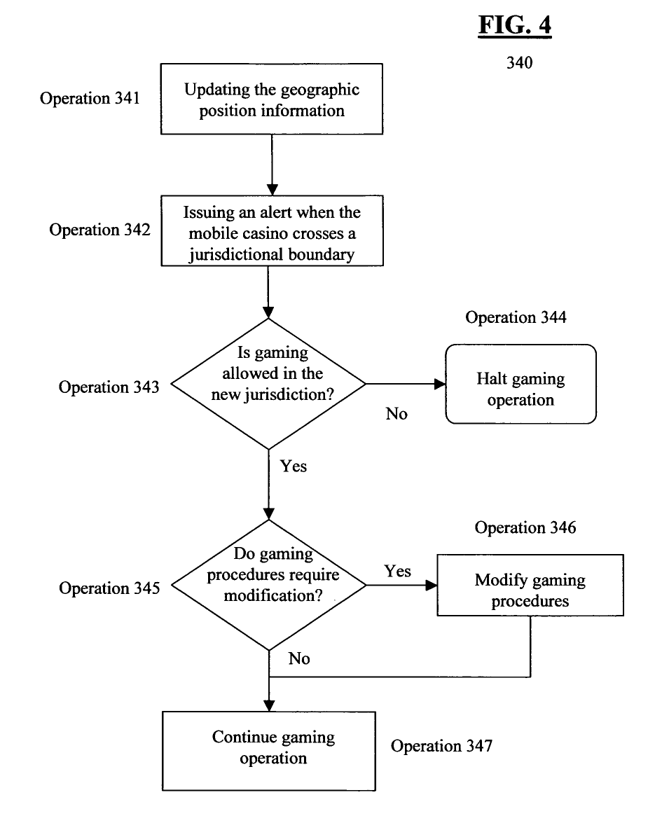

In operation 330, the master computer determines whether the mobile casino is in compliance with laws in various jurisdictions and issues instructions to change the operating mode of gaming equipment in the mobile casino for that purpose. As shown in FIG. 4, for example, the master computer is updated with the position information in operation 341. The master computer issues a notification or alert when the mobile casino enters a new jurisdiction (operation 342). In operation 343, if the mobile casino is about to enter a jurisdiction that prohibits gambling, the master computer issues an instruction to shut down gaming equipment (operation 344).

If gambling is authorized in the new jurisdiction, the master computer determines whether any modifications in gaming procedures are necessary in operation 345. As an example, states may have different payoff amounts for various games. Thus, the master computer may issue an instruction such that the gaming equipment provides different payoff amounts and/or frequencies in operation 346. Then, gambling continues in operation 347.

Referring to FIGS. 3-4, the flowcharts are generally described in terms of a method. The described operations may be implemented in segments of software code and/or as hardware. For example, the operations 343 and 344 may include software code instructions to access a database of gaming criteria in various jurisdictions that is stored on a magnetic disk, a magneto-optical disk, an optical disk, or a CD-ROM.

More specifically, the systems, methods, and techniques described here may be implemented in digital electronic circuitry, or in computer hardware, firmware, software, or in combinations of them. Apparatus embodying these techniques may include appropriate input and output devices, a computer processor, and a computer program product tangibly embodied in a machine-readable storage device for execution by a programmable processor. A process embodying these techniques may be performed by a programmable processor executing a program of instructions to perform desired functions by operating on input data and generating appropriate output. The techniques may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of implementations have been described. Nevertheless, it will be understood that various modifications may be made without departing from the spirit and scope of the invention. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

I claim:

1. A method of gaming in a mobile casino supervised from a supervisory location, comprising:
collecting data from the mobile casino; and
sending the data to the supervisory location.

2. The method of claim 1, wherein the collecting data comprises collecting payoff information.

3. The method of claim 1, wherein the collecting data comprises collecting gaming revenue information.

4. The method of claim 1, wherein the collecting data comprises collecting video surveillance information.

5. The method of claim 1, wherein the collecting data comprises collecting geographic position information.

6. The method of claim 5, further comprising:
changing an operating mode of gaming equipment in the mobile casino based on the geographic position information.

7. The method of claim 1, wherein the mobile casino comprises a train such that the collecting data comprises collecting data from the train.

8. The method of claim 1, wherein the mobile casino comprises a bus such that the collecting data comprises collecting data from the bus.

9. The method of claim 1, wherein the mobile casino comprises a trailer such that the collecting data comprises collecting data from the trailer.

10. The method of claim 1, wherein the mobile casino comprises a boat such that the collecting data comprises collecting data from the boat.

11. The method of claim 1, wherein the sending the data comprises wireless transmission of the data to the supervisory location.

12. The method of claim 1, wherein the supervisory location comprises a fixed location such that the sending the data comprises sending the data to the fixed location.

13. The method of claim 1, further comprising downloading the data to a master computer at the supervisory location.

14. A mobile gaming system installed in a vehicle and supervised from a supervisory location, comprising:
gaming equipment;
an on-board computer linked to the gaming equipment;
a vibration absorbing mounting device mounting the gaming equipment to the vehicle; and
a master computer at the supervisory location receiving data from and sending data to the on-board computer.

15. The mobile gaming system of claim 14, wherein the on-board computer further comprises a global positioning system module reporting the position of the vehicle.

16. The mobile gaming system of claim 14, wherein the vehicle comprises a train.

17. A computer readable medium having embodied thereon a computer program for processing by a computer to thereby conduct gaming in a mobile casino, the computer program comprising:
a first code segment instructing to collect gaming data and position information from the mobile casino;
a second code segment instructing to transmit the gaming data and position information to a control center; and
a third code segment instructing to calculate gaming revenue at each location of the mobile casino based on the gaming data and the position information.

18. A method of producing a mobile casino, comprising:
mounting gaming equipment in a compartment of a land-based motorized vehicle.

19. The method of claim 18, further comprising:
facilitating communication between the motorized vehicle and a remote supervisory location.

20. The method of claim 18, wherein the mounting the gaming equipment comprises mounting the gaming equipment with shock absorption devices.
